(19) United States
(12) Patent Application Publication
(10) Pub. No.: US 2013/0322370 A1
(43) Pub. Date: Dec. 5, 2013

(54) SIGNALING REDUCED USER EQUIPMENT PERFORMANCE IN WIRELESS COMMUNICATION SYSTEMS

(71) Applicant: QUALCOMM Incorporated, San Diego, CA (US)

(72) Inventors: Gene Fong, San Diego, CA (US); Peter Gaal, San Diego, CA (US); Masato Kitazoe, Hachiouji-shi (JP)

(21) Appl. No.: 13/906,061

(22) Filed: May 30, 2013

Related U.S. Application Data
(60) Provisional application No. 61/654,710, filed on Jun. 1, 2012.

(51) Int. Cl. H04W 72/04; H04W 8/24

(52) U.S. Cl. CPC H04W 72/042; H04W 8/24
USPC 370/329

(57) ABSTRACT

Methods, systems, and devices are described for signaling reduced user equipment (UE) feature support in wireless networks. A UE may retrieve a performance capability of the UE in relation to a feature of a wireless communication system for which a minimum performance capability is specified by a wireless communication standard. The UE may accordingly signal to a base station a capability of the UE to support the wireless communication feature at a reduced level that is below the minimum performance capability specified by the wireless communication standard, and communicate with the base station using the feature at the reduced level based on an indication from the base station.

### CROSS REFERENCES

The present Application for Patent claims priority benefit of co-pending U.S. Provisional Patent Application No. 61/654,710 by Fong et al., entitled “Signaling Reduced User Equipment Performance in Wireless Communication Systems,” filed Jun. 1, 2012, assigned to the assignee hereof, and expressly incorporated by reference herein.

### BACKGROUND

The following relates generally to wireless communication, and more specifically to signaling user equipment (UE) feature support in wireless networks. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple mobile devices. Base stations may communicate with mobile devices on downstream and upstream links. Each base station has a coverage range, which may be referred to as the coverage area of the cell. As wireless network communication systems continue to develop and become more advanced, some devices may support features that improve the quality or speed of wireless communications over the systems. The use of such features may be controlled by commonly accepted standards. For example, a standard may set forth a set of minimum requirements for a certain feature to be used during communications between a UE and a base station. However, in certain cases, UEs that do not meet the minimum requirements may still benefit from using the feature during base station communications.

### SUMMARY

Methods, systems, and devices for signaling a reduced or diminished support for a wireless communication feature at a UE in a wireless communications system are provided. A UE may signal to a base station a diminished capability of supporting a particular wireless communication feature, and the UE may be permitted to communicate with the base station using the wireless communication feature at a reduced level that is below the minimum requirements set forth in a wireless communication standard.

In some examples, novel functionality is described for wireless communications. A UE may retrieve a performance capability of the UE in relation to a feature of the wireless communication system for which a minimum performance capability is specified by a wireless communication standard. The UE may signal to the base station that the UE is capable of supporting the wireless communication feature at a reduced level that is below a minimum performance capability specified by the wireless communication standard. The UE may then communicate with the base station using the feature at the reduced level in response to an indication from the base station.

In certain examples, the indication may include communication feature at the reduced level from the base station, and the use of the wireless communication feature at the reduced level by the UE may be conditioned on the permission received from the base station. In certain examples, the indication may include a set of scheduling instructions from the base station for transmitting uplink data to the base station using the wireless communication feature. Additionally or alternatively, the indication may be received as a message from the base station authorizing communication using the feature at the reduced level. In certain examples, the indication may include a radio resource control (RRC) configuration message enabling use of the feature. In certain examples, the indication may include receiving a message from the base station rejecting communications using the feature at the reduced level and refraining from communicating with the base station using the feature at the reduced level in response to the message.

In some examples, the UE may retrieve the performance capability of the UE by retrieving a stored indication that that the performance capability of the UE is less than the minimum performance capability associated with supporting the wireless communication feature, as specified by the wireless communication standard. The signaling of the performance capability of the UE to the base station may be in connection with a capabilities exchange process. In certain examples, the signaling to the base station may include indicating support for the feature at one or more of a plurality of predetermined performance levels. In some examples, the performance capability of the UE may include support for a carrier aggregation feature of the wireless communication system. In some such examples, signaling to the base station may include or refer to a capability of the UE to support the carrier aggregation feature at the reduced level in an uplink direction and at a level specified by the wireless standard in the downlink direction. The UE may transmit uplink signals to the base station at a reduced output power. The UE may accordingly receive downlink transmissions from the base station in accordance with the wireless standard.

In some examples, identifying the performance capability of the UE may include identifying the performance capability of the UE in relation to a plurality of frequency bands. In some such examples, the UE may communicate with the base station using the wireless communication feature at the reduced level on one or more of the plurality of frequency bands.

In some examples, the wireless communication standard may include a version of a Long-Term Evolution (LTE) standard. For example, the wireless communication feature may be carrier aggregation as set forth in the LTE-Advanced standards.

In additional examples, a UE apparatus may include a UE capability module, a signaling module, and a communications module. The UE capability module may be configured to retrieve a performance capability of the UE in relation to a feature of the wireless communication system for which a minimum performance capability is specified by a wireless communication standard. The signaling module may be configured to signal to a base station a capability of the UE to support the wireless communication feature at a reduced level that is below a minimum performance capability specified by the wireless communication standard. The communications module may be configured to communicate with the base station using the feature at the reduced level in response to an indication from the base station.

In further examples, a UE apparatus may include means for retrieving a performance capability of the UE in relation to a feature of the wireless communication system for which a minimum performance capability is specified by a wireless communication standard, means for signaling to a base station a capability of the UE to support the wireless communication feature at a reduced level that is below the minimum performance capability specified by the wireless communication standard, and means for communicating with the base station using the feature at the reduced level based on an indication from the base station.

In other examples, a computer program product for wireless communication using a user equipment (UE) may include a tangible computer-readable medium. The tangible computer-readable medium may include code for retrieving a performance capability of the UE in relation to a feature of the wireless communication system for which a minimum performance capability is specified by a wireless communication standard, code for signaling to a base station a capability of the UE to support the wireless communication feature at a reduced level that is below the minimum performance capability specified by the wireless communication standard, and code for communicating with the base station using the feature at the reduced level based on an indication from the base station.

In still other examples, a method for wireless communication using a base station is described in which the base station receives a capability information message from a user equipment (UE) communicatively coupled with the base station; determines from the capability information message that the UE supports a wireless communication feature at a reduced level that is below a minimum performance capability specified by a wireless communication standard for supporting the wireless communication feature; and indicates to the UE whether the wireless communication feature can be used at the reduced level.

In certain examples, the indicating may include transmitting scheduling instructions to the UE for transmitting uplink data to the base station using the wireless communication feature at the reduced level. Additionally or alternatively, the indicating may include transmitting a message to the UE expressly indicating the permission to use the wireless communication feature at the reduced level.

The capability information message may additionally or alternatively be used to determine that communicating with the UE using the wireless communication feature at the reduced level is possible. In such examples, the indicating may occur in response to the determination. In certain examples, the capability information message may be used by the base station to determine that a received signal strength of the UE is sufficient to enable uplink communications using the wireless feature at the reduced level. The base station may communicate with the UE in an uplink direction using the wireless communication feature at the reduced level in response to the determination that the received signal strength of the UE is sufficient. In such examples, the base station may communicate with the UE using the wireless communication feature in the one of the uplink direction or the downlink direction and communicate with the UE without using the wireless communication feature in the other direction. In certain examples, the base station may identify the performance capability of the UE in relation to a plurality of frequency bands and communicate with the UE using the wireless communication feature at the reduced level over one or more of the plurality of frequency bands.

In some of these examples, the wireless communication feature may be a carrier aggregation feature, and the wireless communication standard may include a version of a Long-Term Evolution (LTE) standard. For example, the wireless communication feature may be carrier aggregation as set forth in the LTE-Advanced standard.

In still other examples, a base station apparatus may include means for receiving a capability information message from a user equipment (UE) communicatively coupled with the base station, means for determining from the capability information message that the UE supports a wireless communication feature at a reduced level that is below a minimum performance capability specified by a wireless communication standard for supporting the wireless communication feature, and means for indicating to the UE whether the wireless communication feature can be used at the reduced level.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system;

FIG. 2 shows a block diagram of an example wireless communications system that includes a base station and a user equipment in accordance with various embodiments;

FIG. 3 shows a block diagram of an example of wireless communications between a UE and a base station;

FIG. 4A shows a block diagram of an exemplary UE capability information message;

FIG. 4B shows a block diagram of an exemplary UE capability information message;

FIG. 4C shows a block diagram of an exemplary UE capability information message;

FIG. 5 shows a block diagram of an example of wireless communications between a UE and a base station;

FIG. 6 shows a block diagram of an example of a UE;

FIG. 7 shows a block diagram of an example of a base station;

FIG. 8 is a flowchart of an example method for signaling reduced UE feature support in wireless networks from a UE perspective;

FIG. 9 is a flowchart of an example method for signaling reduced UE feature support in wireless networks from a UE perspective;

FIG. 10 is a flowchart of an example method for signaling reduced UE feature support in wireless networks from a base station perspective; and

FIG. 11 is a flowchart of an example method for signaling reduced UE feature support in wireless networks from a base station perspective.

### DETAILED DESCRIPTION

Methods, systems, and devices for signaling reduced user equipment (UE) feature support in wireless communications systems are described. A UE may retrieve a performance capability of the UE in relation to a feature of the wireless communication system, such as carrier aggregation, for which a minimum performance capability is specified by a wireless communication standard. Nevertheless, such a UE may still benefit from using the wireless communication feature at a diminished or reduced level. Thus, the UE may signal to a base station that the UE is capable of supporting the wireless communication feature at a reduced level that is below the minimum performance capability specified by the wireless communication standard, and communicate with the base station using the feature at the reduced level in response to the signaling.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

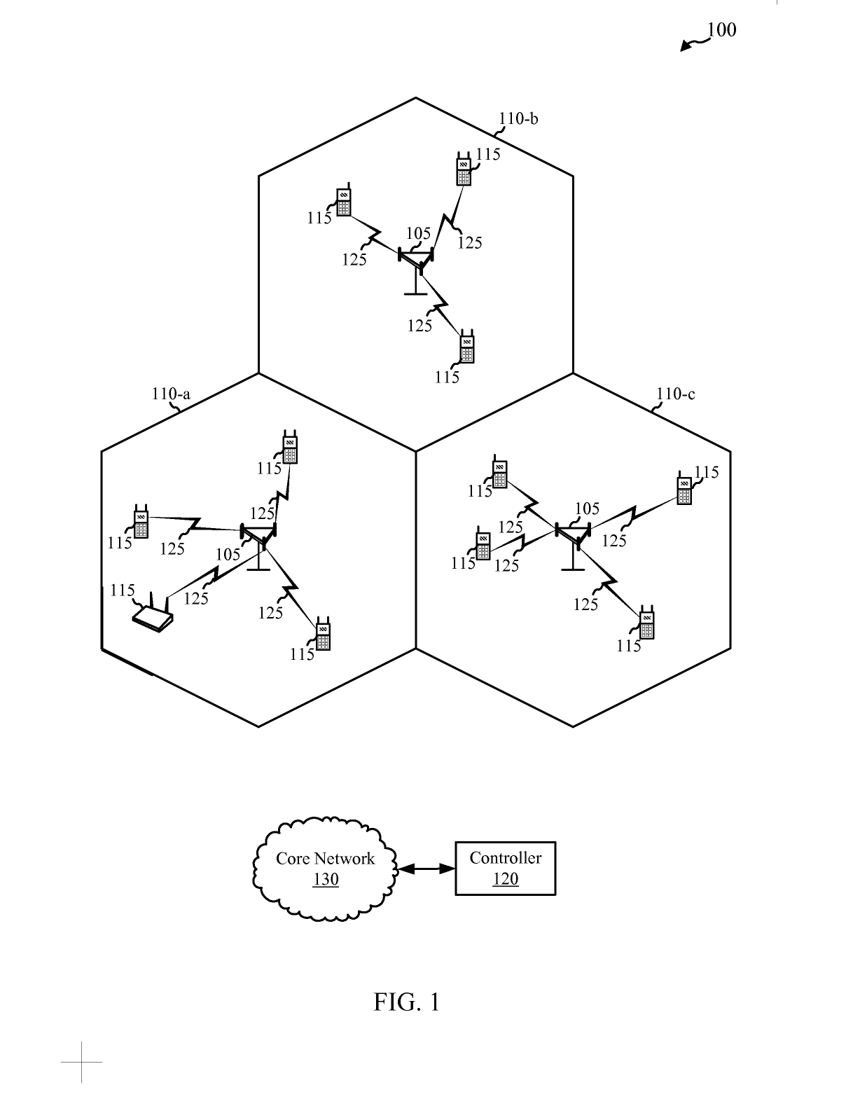

Referring first to FIG. 1, a block diagram illustrates an example of a wireless communications system 100 in accordance with various embodiments. The system 100 includes base stations 105, mobile devices 115, a base station controller 120, and a core network 130 (the controller 120 may be integrated into the core network 130 in some embodiments; in some embodiments, controller 120 may be integrated into base stations 105). The system 100 may support operation on multiple different wireless communications networks. For example, the system may provide GSM EDGE Radio Access Network (GERAN), UTRAN and E-UTRAN capability for mobile devices 115. Each wireless communications network can transmit modulated signals according to the protocols of the particular network. System 100, for example, shows transmissions 125 between mobile devices 115 and base stations 105. The transmissions 125 may include uplink and/or reverse link transmission, from a mobile device 115 to a base station 105, and/or downlink and/or forward link transmissions, from a base station 105 to a mobile device 115. Each modulated signal may be a Code Division Multiple Access (CDMA) signal, Time Division Multiple Access (TDMA) signal, Frequency Division Multiple Access (FDMA) signal, Orthogonal FDMA (OFDMA) signal, Single-Carrier FDMA (SC-FDMA) signal, etc. Each modulated signal may be sent on a different carrier and may carry control information (e.g., pilot signals), overhead information, data, etc.

The mobile devices 115 may be any type of mobile station, mobile device, access terminal, subscriber unit, or user equipment, and are generally referred to herein as mobile devices or user equipment. The mobile devices or user equipment 115 may include cellular phones and wireless communications devices, but may also include personal digital assistants (PDAs), smartphones, other handheld devices, netbooks, notebook computers, tablet computers, etc. Thus, the term mobile device should be interpreted broadly hereinafter, including the claims, to include any type of wireless or mobile communications device. In certain examples, the mobile devices 115 may be referred to as UEs. According to various embodiments, mobile devices 115 may be capable of communication using one or more wireless communications networks available in system 100.

In situations where one or more of the wireless communications networks available using system 100 provide enhanced communications capabilities, users having mobile devices 115 capable of communications on such networks may desire that such enhanced communications capabilities be available on their mobile devices 115. For example, if system 100 supports GERAN, UTRAN, and E-UTRAN, users of mobile devices 115 that are capable of operating in E-UTRAN may desire that E-UTRAN services be available if they are within an E-UTRAN service area. Additionally, users may pay a premium for access to E-UTRAN services, thus further increasing the desire that E-UTRAN services be available when the users are within an E-UTRAN service area. Thus, although such mobile devices 115 may be capable of communications using GERAN or UTRAN, use of these networks may be less favorable.

The base stations 105 may wirelessly communicate with the mobile devices 115 via one or more base station antennas. The base stations 105 may be configured to communicate with the mobile devices 115 under the control of the controller 120 via multiple carriers. Each of the base station 105 sites can provide communication coverage for a respective geographic area 110. In some embodiments, base stations 105 may be referred to as a NodeB, evolved NodeB (eNodeB), Home NodeB, and/or Home eNodeB. The coverage area for each base station 105 here is identified as 110-a, 110-b, or 110-c. As will be readily understood, in systems 100 that provide capability of communications using multiple different networks, each base station 105 may include capabilities for connection to one or more of the available networks. Continuing with the above example, system 100 may provide GERAN, UTRAN, and E-UTRAN services, with some base stations 105 providing only E-UTRAN services and other base stations 105 providing GERAN, UTRAN, and E-UTRAN services. Furthermore, the coverage areas 110 of base stations 105 may overlap. Mobile devices 115 may move between coverage areas 110-a, 110-b, and 110-c, with continuity of communications maintained between base stations 105 and mobile devices 115.

In some cases, a wireless communication feature may be supported by some, but not all, mobile devices 115 or base stations in the system 100. To use such features, the mobile devices 115 may from time to time signal their support for such features to the base stations 105, and the base stations may configure the mobile devices 115 to communicate using the features when supported. One such wireless communication feature may be carrier aggregation. Carrier aggregation may expand the effective bandwidth provided to a mobile device 115 by aggregating multiple component carriers into a larger overall transmission bandwidth. Use of such features may typically be governed by an applicable wireless communications standard, such as a standard propagated by a collaborative body or a standard defined by a network provider. Such standards may define a set of minimum requirements for using the wireless communication feature.

One example of such a standard is the LTE-Advanced standard developed by the 3rd Generation Partnership Project (3GPP). 3GPP Technical Specification 36.101 in the LTE-A standard sets forth a set of performance requirements to be met by a mobile device 115 supporting carrier aggregation. These performance requirements may include requirements for, for example, output power, frequency error requirements, transmit intermodulation requirements, reference sensitivity power levels, power input levels, adjacent channels, blocking characteristics, spurious response, spurious emissions, receiver image, and the like.

Under some standards, a mobile device 115 joining a wireless communication network in system 100 may signal a binary indicator of whether the mobile device 115 supports carrier aggregation, or another wireless feature, in both the uplink direction and the downlink direction for each of the bands associated with carrier aggregation in the network. The mobile device 115 may signal that the mobile device 115 supports carrier aggregation for a band if the mobile device 115 meets all of the requirements described by the standard in both the uplink and the downlink direction for that particular band.

However, it may be possible for a mobile device 115 that does not meet the minimum performance requirements for using a wireless communication feature according to a standard to benefit from using that feature at a reduced or diminished level. Returning to the example of carrier aggregation, a mobile device 115 may be optimized for downlink carrier aggregation as opposed to uplink carrier aggregation, as data traffic is often biased towards the downlink. It is possible that such a mobile device 115 may not be able to meet the minimum performance requirements for uplink carrier aggregation. For example, a mobile device 115 may reduce its transmit power level in order to comply with out-of-band and spurious emission requirements when operating with multiple simultaneous uplink carriers. Under such conditions, the mobile device 115 may not meet the minimum performance requirement for output power with uplink carrier aggregation. Nevertheless, if the mobile device 115 is in close proximity to a base station 105, the reduced output power of the mobile device 115 may still be sufficient to support communication on multiple uplink carriers.

If the mobile device 115 of the foregoing example were to signal to the base station 105 only a binary indicator of whether the mobile device 115 supports carrier aggregation in the uplink direction for a band, the mobile device 115 would signal that it does not support uplink carrier aggregation for that band or band combination because it does not meet the minimum performance requirements of the wireless communication standard. The result of this signaling may be that the mobile device 115 would be unable to use uplink carrier aggregation for that band or band combination.

However, in certain aspects of the present disclosure, a mobile device 115 may be configured to signal a reduced or diminished ability to support a wireless communication feature such as carrier aggregation at a level that is below the minimum performance capability specified by the applicable wireless communication standard for supporting the feature. If the wireless communication feature can be supported between a base station 105 and the mobile device 115 at this reduced level, the base station may enable use of the wireless communication feature in communications with the mobile device 115, even where the mobile device 115 does not meet the minimum performance requirements of the standard for supporting the feature.

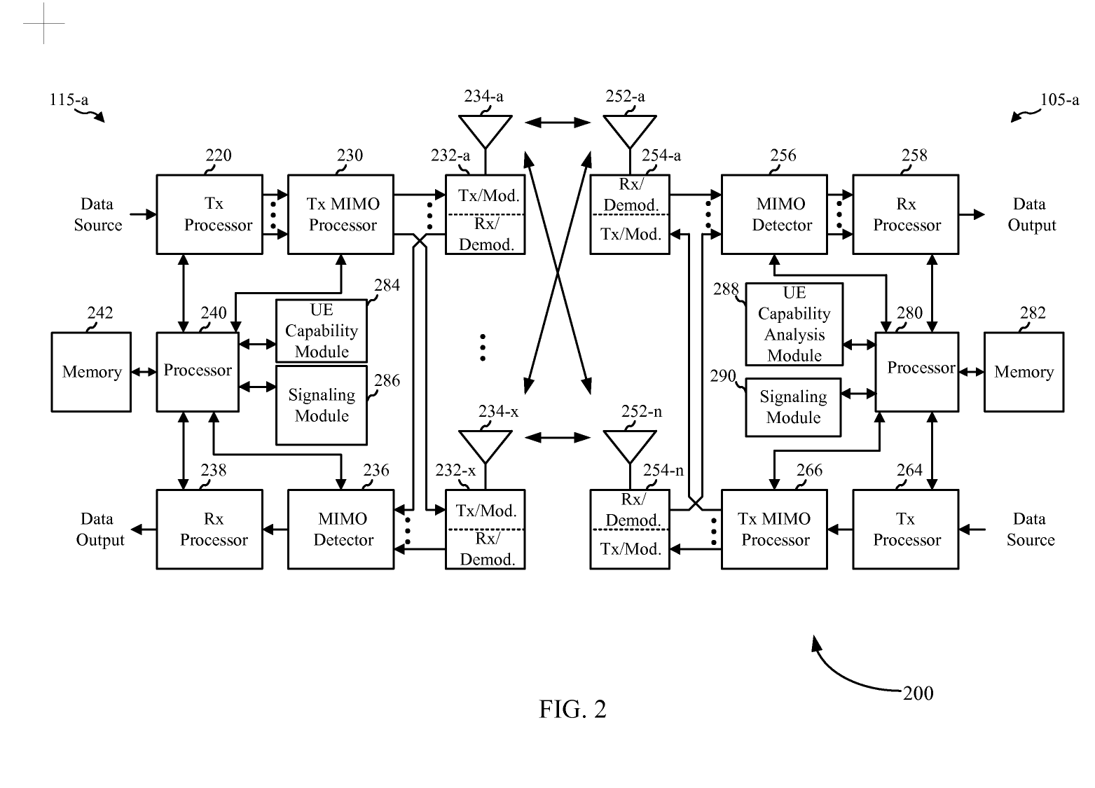

Referring now to FIG. 2, a block diagram of a system 200 including a base station 105-a and a UE 115-a is described. This system 200 may be a portion of the system 100 of FIG. 1. The base station 105-a may be equipped with antennas 232-a through 232-x, and the UE 115-a may be equipped with antennas 232-a through 232-n. UE 115-a and base station 105-a may communicate according to a capabilities exchange process associated with network protocol of one or more wireless communications networks, such as, for example, E-UTRAN, UTRAN, and GERAN, similarly as discussed above. At the UE 115-a, a transmit processor 220 may receive data from a data source and from a processor 240, UE capability module 284, and signaling module 286. In certain examples, one or more aspects of the UE capability module 284 or the signaling module 286 may be implemented by processor 240.

The UE capability module 284 may be configured to retrieve a performance capability for supporting a wireless communication feature (e.g., carrier aggregation) at a level that is less than a minimum performance capability associated with supporting the wireless communication feature as specified by the wireless communication standard. The signaling module 286 may be configured to control signaling between the UE 115-a and the base station 105-a such that the UE 115-a signals a capability of the UE 115-a to support the wireless communication feature at a reduced level that is below the minimum performance capability specified by the wireless communication standard. This signaling may be explicit (e.g., a message confirming the capability of the UE to support the feature at the reduced level) or implicit (e.g., a message containing power levels of the UE, from which the base station may infer support for the feature at the reduced level). In response to an indication from the base station 105-a, the UE may communicate with the base station 105-a using the wireless communication feature at the reduced level. The indication from the base station 105-a may be a message expressly giving permission to the UE 115-a to use the feature at the reduced level. Additionally or alternatively, the indication may be implicit (e.g., the base station 105-a schedules the UE 115-a to use the feature). In one example, the processor 240 may control the transmit processor 220 to implement the wireless communication feature at the reduced level in scheduled communications with the base station.

Transmit processor 220 may receive control information from processor 240, UE capability module 284, and/or signaling module 286. The control information may include, among other information, information related to use of the wireless communication feature. The transmit processor 220 may process (e.g., encode and symbol map) the data, and control information to obtain data symbols and control symbols, respectively. The transmit processor 220 may also generate reference symbols, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the transmit modulators 232-a through 232-x. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a uplink signal. Uplink signals from modulators 232-a through 232-x may be transmitted via the antennas 232-a through 232-x, respectively.

At the base station 105-a, the antennas 252-a through 252-n may receive the uplink signals from the UE 115-a and may provide the received signals to the demodulators 254-a through 254-n, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254-a through 254-n, perform MIMO detection on the received symbols if applicable, and provide detected symbols. A receive processor 258 may process (e.g., demodulate, deinterleave, and decode) the detected symbols, providing decoded data to a data output, and provide decoded control information to a processor 280, or memory 282. Receive processor 258 also may perform error correction on the decoded data to correct bit errors that may be present in the decoded data.

A portion of the data received from UE 115-a at the base station 105-a may include the UE capability information message(s) generated by the signaling module 286 of the UE 115-a. A UE capability analysis module 288 may determine from the UE capability information messages that the UE supports the wireless communication feature at a reduced level that is below a minimum performance capability specified by the wireless communication standard for supporting the wireless communication feature. The UE capability analysis module 288 may determine from the received UE capability information messages and from observed or reported network conditions whether allowing the UE 115-a to use the wireless communication feature at the reduced level is permissible or feasible. If it is determined that the use of the wireless communication feature at the reduced level is permissible, a signaling module 290 of the base station 105-a may signal permission to use the wireless communication feature at the reduced level to the UE 115-a. In certain examples, this permission may be signaled as scheduling data for the UE 115-a to schedule the UE 115-a for communication with the base station using the wireless communication feature at the reduced level. Additionally or alternatively, the permission may be signaled as a message expressly authorizing or permitting the UE 115-a to use the wireless communication feature at the reduced level.

On the uplink, at the base station 105-a, a transmit processor 264 may receive and process data from a data source and from the processor 280 and memory 282. The transmit processor 264 may also generate reference symbols for a reference signal. The symbols from the transmit processor 264 may be precoded by a TX MIMO processor 266 if applicable, further processed by the demodulators 254-a through 254-n (e.g., for SC-FDMA, etc.), and be transmitted to the user equipment 115-a. At the user equipment 115-a, the downlink signals from the base station 105-a may be received by the antennas 234, processed by the demodulators 232, detected by a MIMO detector 236 if applicable, and further processed by a receive processor 238 to obtain decoded data and control information sent by the base station 105-a. The receive processor 238 may provide the decoded data to a data output and decoded control information to the processor 240. The components of the user equipment 115-a may, individually or collectively, be implemented with one or more Application Specific Integrated Circuits (ASICs) adapted to perform some or all of the applicable functions in hardware. Each of the noted modules may be a means for performing one or more functions related to operation of the systems 100, 200 of FIGS. 1-2. Similarly, the components of the base station 105-a may, individually or collectively, be implemented with one or more Application Specific Integrated Circuits (ASICs) adapted to perform some or all of the applicable functions in hardware. Each of the noted modules may be a means for performing one or more functions related to operation of the systems 100, 200 of FIGS. 1-2.

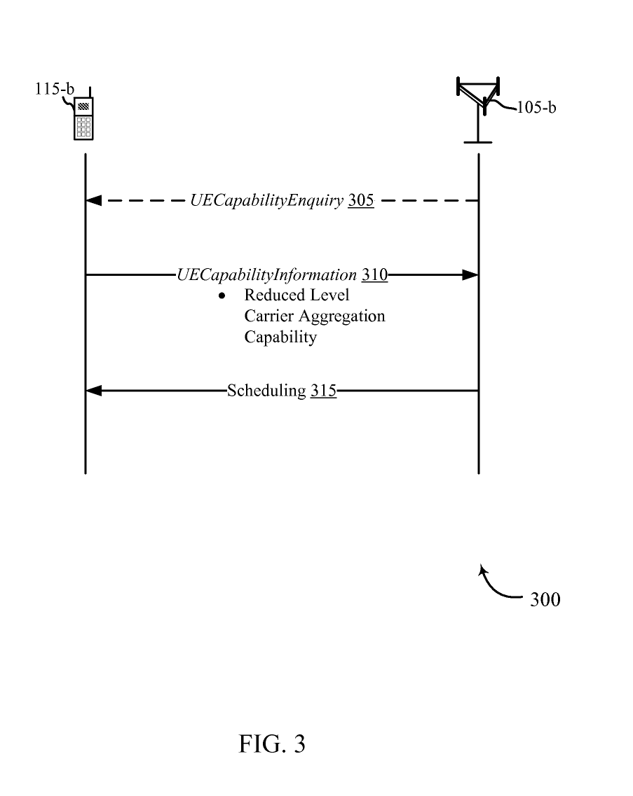

FIG. 3 illustrates an example system 300 in which a UE 115-b communicates with a base station 105-b during a capabilities exchange process to set up or modify the transmission of data or voice communication between the UE 115-b and the base station 105-b. The system 300 of the present example may be an example of any of the systems 100, 200 described above with reference to FIG. 1 or FIG. 2. Thus, the UE 115-b may be an example of any of the mobile devices 115 described in FIG. 1 or 2, and the base station 105-b may be an example of any of the base stations 105-b described in FIG. 1 or 2.

As shown in FIG. 3, the UE 115-b may signal its capabilities, including support for wireless communications features, to the base station 105-b in a UE capability information message 310. In certain examples, the UE 115-b may transmit the UE capability information message 310 to the base station 105-b in response to receiving a UE capability enquiry message 305 from the base station 105-b. Additionally or alternatively, the UE 115-b may transmit the UE capability information message 310 to the base station 105-b in response to a determination by the UE that the capabilities of the UE have changed from what was previously reported to the base station 105-b. In certain examples, the UE capability enquiry message 305 and the UE capability information message 310 may be Radio Resource Control (RRC)-layer messages, and the message content may include bitmap content.

As described above with reference to FIGS. 1-2, in some cases it may be beneficial for a UE 115-b that does not meet all of the requirements of a standard for supporting a particular feature, such as carrier aggregation, to still communicate using the feature to the extent practicable based on network conditions. Thus, the UE capability information message 310 of the present example may signal to the base station 105-b that the UE 115-b is capable of supporting carrier aggregation, but at a diminished or reduced level that is below the minimum requirements of an accepted wireless communication standard. The wireless communication standard may be, for example, an industry standard or a requirement of an owner or operator of a particular network.

In response to receiving the UE capability information message 310, the base station 105-b may determine whether network conditions permit use of carrier aggregation at the UE 115-b below the minimum requirements of the standard. For example, the base station 105-b may determine from the UE capability information message 310 that the UE 115-b does not meet the minimum requirement for output power defined by the standard for supporting uplink carrier aggregation. However, the base station 105-b may further determine from the UE capability information message 310 and/or a measured signal strength of the UE that uplink carrier aggregation is possible and permit the UE 115-b to communicate with the base station 105-b using uplink carrier aggregation. On the other hand, if the base station 105-b determines that uplink carrier aggregation is not possible or would not meet a quality control requirement, the base station 105-b may determine not to permit the UE 115-b to utilize uplink carrier aggregation in its communications with the base station 105-b.

Upon determining that uplink carrier aggregation is permissible for the UE 115-b, the base station 105-b may indicate to the UE 115-b its permission to employ uplink carrier aggregation at the reduced level. In certain examples, the base station 105-b may indicate the permission implicitly by transmitting one or more scheduling messages 315 to the UE 115-b to schedule data or voice transmissions between the base station 105-b and the UE 115-b using uplink carrier aggregation. Additionally or alternatively, the base station 105-b may transmit a message, such as an RRC configuration message, to the UE 115-b that enables uplink carrier aggregation at the reduced level by expressly signaling permission to use uplink carrier aggregation. Alternatively, upon determining that uplink carrier aggregation is not permitted for the UE 115-b, the base station 105-b may transmit one or more scheduling messages 315 to the UE 115-b to schedule data or voice transmissions between the base station 105-b and the UE 115-b that do not use uplink carrier aggregation and/or transmit a message to the UE 115-b expressly rejecting communication using uplink carrier aggregation at the reduced level. In response to such a rejection, the UE 115-b may refrain from communicating with the base station using uplink carrier aggregation at the reduced level.

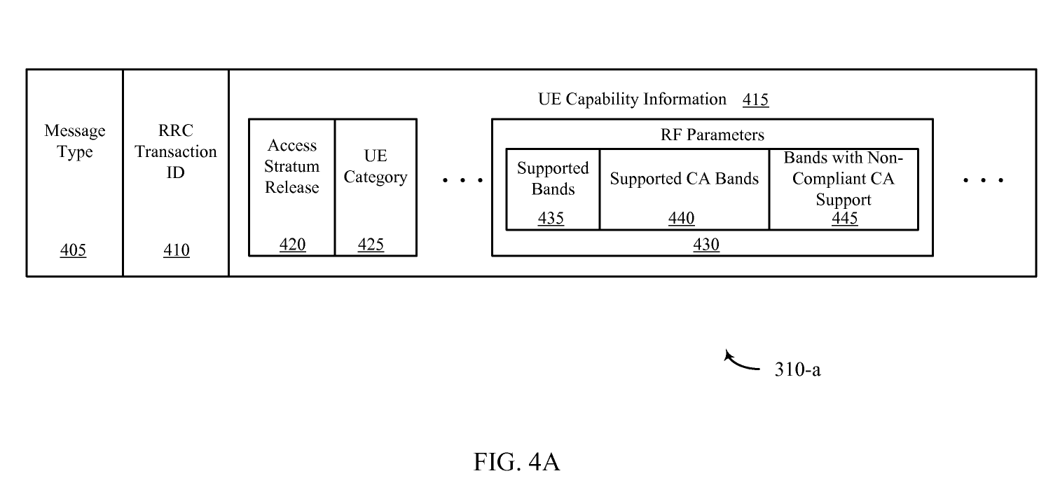

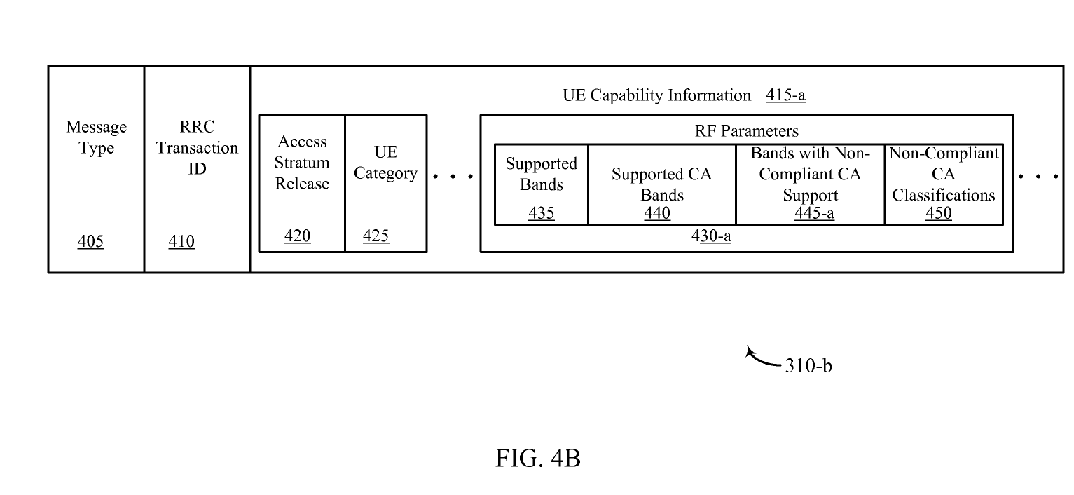

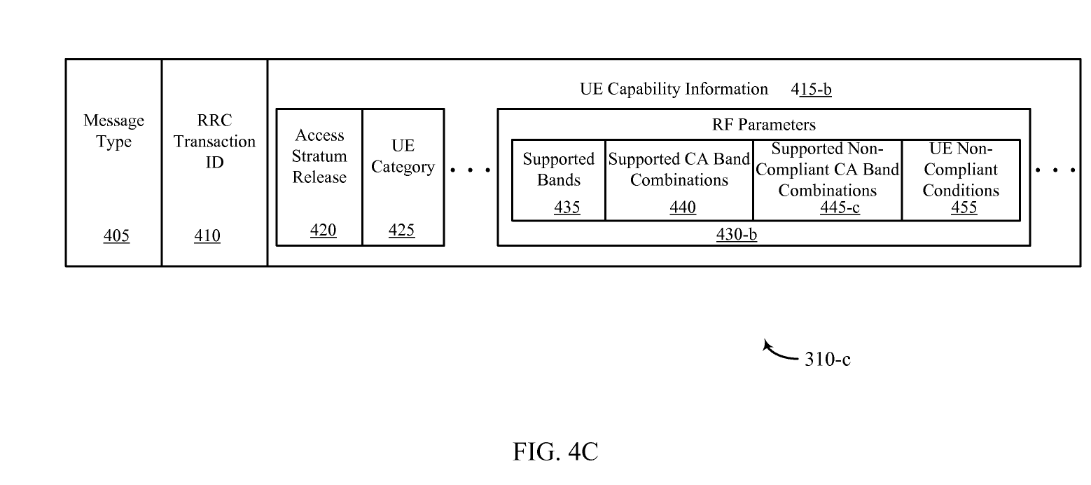

FIGS. 4A-4C illustrate different examples of a UE capability information messages 310 that may be transmitted by a UE (e.g., UE 115 of FIGS. 1-3) to a base station (e.g., base station 105 of FIGS. 1-3) during a capabilities exchange process to indicate the communication capabilities and features supported by the UE. The UE capability information messages 310 of these Figures may be examples of the UE capability information message 310 described above with reference to FIG. 3. Additionally or alternatively, the UE capability information messages 310 described in FIGS. 4A-4C may, in some examples, be versions or modifications of the UECapabilityEnquiry message described in the 3GPP TS 36.331 LTE Radio Resource Control Protocol specification.

Each of the UE capability information messages 310 of FIGS. 4A-4C may include a message type field 405 identifying the message as a UE capability information message, an RRC transaction ID field 410, and a UE capability information field 415. Each of the UE capability information fields 415 may include access stratum release information 420 defining the version of a standard supported by the UE, UE category information 425 indicating a category of the UE as defined by the standard, and RF parameters information 430. The UE capability information 415 may include also include other information, not shown in FIGS. 4A-4C for the sake of clarity.

In the example UE capability information message 310-a of FIG. 4A, the RF parameters information 430-a may include supported bands information 435, supported carrier aggregation bands information 440, and bands with non-compliant CA support information 445-a. The supported bands information 435 may indicate on which of a number of bands defined by the standard the UE is capable of transmitting and receiving data. For example, the supported bands information may indicate which E-UTRA radio frequency bands are supported by the UE, and whether each supported band is available in full or half duplex operation.

The supported band carrier aggregation band combinations information 440 may define the bands defined by the standard for which the UE is capable of providing carrier aggregation communications in compliance with the minimum requirements of the standard. In certain examples, the supported carrier aggregation bands information 440 may include information regarding whether each supported band is capable of providing carrier aggregation communications in an uplink direction, a downlink direction, or both.

In addition to the supported carrier aggregation band information 440 specifying the band or band combinations for which the UE is capable of supporting carrier aggregation in full compliance with the standard, the RF parameters information 430-a may further provide the bands with non-compliant carrier aggregation support information 445-a to indicate bands for which the UE is capable of supporting carrier aggregation, but at a level that is not compliant with the minimum requirements of the standard for supporting carrier aggregation.

The example UE capability information message 310-b shown in FIG. 4B may be similar to that of FIG. 4A, with the UE capability information message 310-b of FIG. 4B including an additional field in the RF parameters 430-b that specifies non-compliant carrier aggregation specifications information 450. The non-compliant carrier aggregation specifications information 450 may indicate details regarding the non-compliant carrier aggregation supported for each band. For example, different degrees of non-compliant carrier aggregation support may be divided into a finite number of categories indicative of different types of deficiencies or combinations of deficiencies with regard to meeting the minimum requirements for supporting carrier aggregation under the standard. Each band for which the UE supports non-compliant carrier aggregation may be matched to one of these predefined categories, and the category associated with each of the bands indicated in the bands with non-compliant carrier aggregation support information 445-a may be specified in the non-compliant carrier aggregation specifications information 450.

In certain examples, the categories may be defined according to UE output power noncompliance, incomplete band support noncompliance (e.g., carrier aggregation supported on only the lower, middle, or upper portion of the specified band), frequency error noncompliance, transmit intermodulation noncompliance, reference sensitivity power level noncompliance, power input level noncompliance, adjacent channel noncompliance, blocking characteristics noncompliance, spurious response noncompliance, spurious emissions noncompliance, receiver image noncompliance, receiver image noncompliance, other types of noncompliance, and/or combinations thereof. In additional or alternative examples, the non-compliant carrier aggregation specifications information 450 may indicate a type of non-compliancy associated with carrier aggregation support for each indicated band without assigning each indicated band to a predetermined category of non-compliance.

The example of the UE capability information message 310-c shown in FIG. 4C may be similar to the examples shown in FIGS. 4A and 4B, except the RF parameters information 430-c in the example of FIG. 4C may include a field of UE non-compliant conditions information 455. The UE non-compliant conditions information 455 may include characteristics or parameters of the UE that are below the minimum requirements of the wireless communication standard in effect for supporting carrier aggregation.

The UE non-compliant conditions information 455 may include data bout the UE including, but not limited to, the current specifications or performance of the UE with respect to output power, frequency error, transmit intermodulation, reference sensitivity power levels, power input levels, adjacent channels, blocking characteristics, spurious response, spurious emissions, receiver image, and/or other relevant data about non-compliant conditions at the UE. This information 455 may be used by a base station to determine whether or not network conditions permit the non-compliant, diminished support of carrier aggregation for the specified bands by the UE.

In certain examples, both the non-compliant carrier aggregation classifications information 450 in the example of FIG. 4B and the non-compliant UE conditions information 455 in the example of FIG. 4C may be included in a single or multiple fields of a UE capability information message.

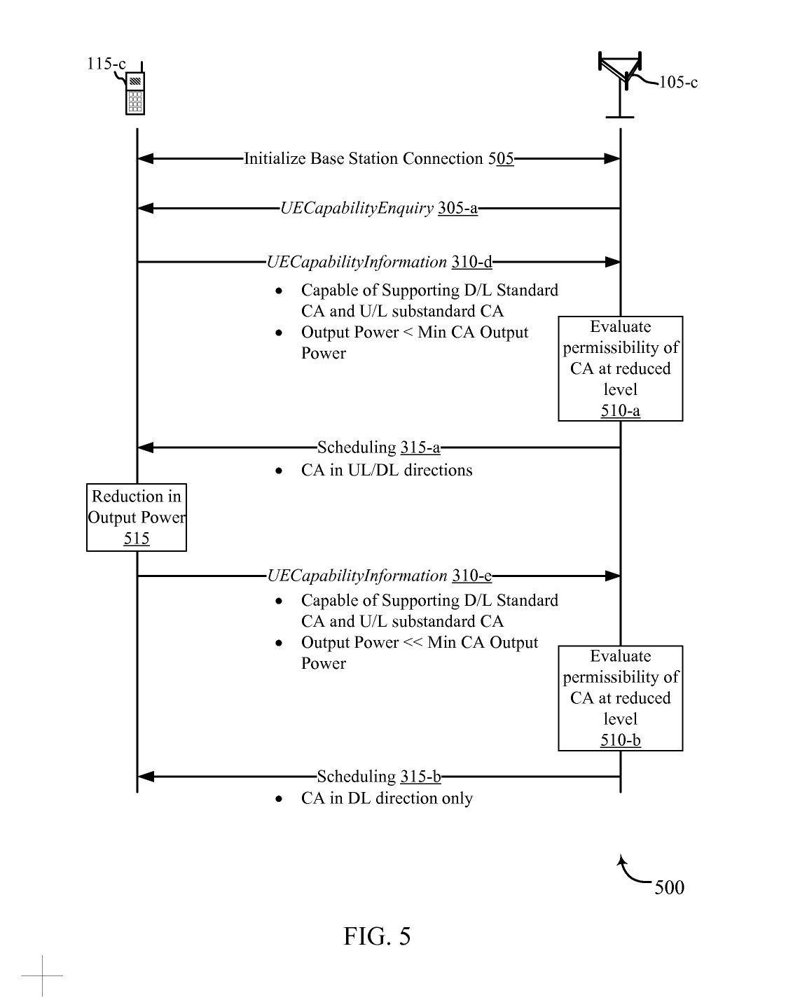

FIG. 5 illustrates another example system 500 in which a UE 115-c communicates with a base station 105-c to set up or modify the transmission of data or voice communication between the UE 115-c and the base station 105-c. The system 500 of the present example may be an example of any of the systems 100, 200, 300 described above with reference to FIGS. 1-3.

After a connection with the base station 105-c has been initialized 505, the base station 105-c may transmit a UE capability enquiry message 305-a to the UE 115-c. The UE capability enquiry message 305-a may be an example of the UE capability enquiry message 305 described above with reference to FIG. 3. In response, the UE 115-c may signal its capabilities, including support for wireless communications features, to the base station 105-a in a first UE capability information message 310-d. The UE capability information message 310-a may be an example of any of the UE capability information messages 310 described above with reference to FIGS. 3-4C.

The first UE capability information message 310-d of the present example may signal to the base station 105-c that the UE 115-c is capable of supporting carrier aggregation, but at a diminished or reduced level due to the output power of the mobile device 115-c being lower than a minimum output power required by an applicable standard (3GPP standard, wireless carrier-specific standard, or other standard) for supporting carrier aggregation. For example, the UE 115-c may be close enough to the base station 105-c that it is not appropriate to transmit at maximum output power.

In response to receiving the UE capability information message 310-d, the base station 105-c may perform an evaluation 510-a of the permissibility of using the diminished or reduced level of carrier aggregation offered by the UE 115-c to communicate with the UE 115-c. In the present example, the base station 105-c may determine that even though the UE 115-b is operating at an output power that is less than the minimum output power required by the standard to support uplink carrier aggregation, the base station 105-c may determine that the output power of the UE 115-c is sufficient for supporting uplink carrier aggregation given the network conditions. Accordingly, the base station may transmit one or more scheduling messages 315-a to the UE 115-c to schedule the UE to communicate with the base station 105-c using carrier aggregation in both the uplink direction.

Continuing with the present example, the UE 115-c may eventually move to a different location or network conditions may change such that the UE 115-c reduces 515 its output power event further. In response to determining that the first UE capability information message 310-d is no longer accurate, the UE 115-c may transmit a new UE capability information message 310-e to the base station 105-c. In the new UE capability information message 310-e, the UE 115-c may indicate to the base station that the UE 115-c is still capable of supporting downlink carrier aggregation in compliance with the standard, that the UE 115-c still has the technical capability of performing uplink carrier aggregation, but that the output power of the UE 115-c is now much less than the minimum output power specified by the applicable standard for supporting carrier aggregation. Using this new information, the base station 105-c may reevaluate 510-b the permissibility of using the diminished or reduced level of carrier aggregation offered by the UE 115-c to communicate with the UE 115-c. The base station 105-c may determine that communications with the UE 115-c using carrier aggregation are still permissible in the downlink direction, but no longer in the uplink direction. Accordingly, the base station 105-c may transmit further scheduling messages 315-b to the UE 115-c to schedule communications with the UE 115-c using carrier aggregation in only the downlink direction.

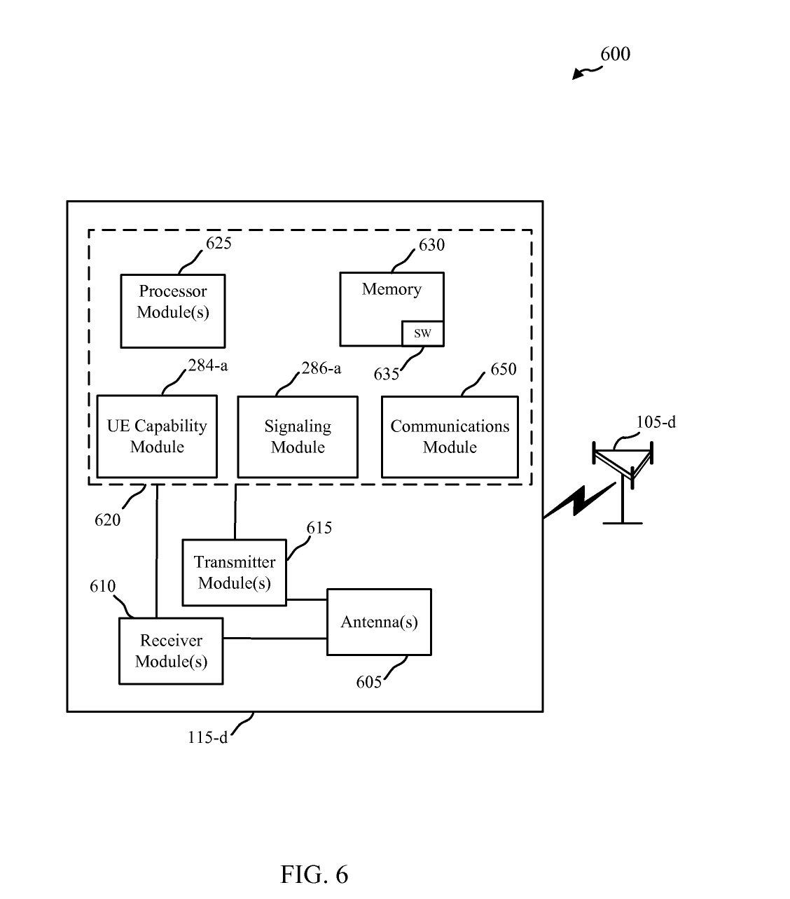

FIG. 6 is an example wireless communication system 600 that provides for the use of a wireless communication feature at a reduced level according to the principles described herein. The system 600 includes a UE 115-d that may communicate with a base station 105-d to receive access to one or more wireless networks, as described above. The UE 115-d may be an example of any of the UEs 115 described above with reference to the preceding Figures, and the base station 105-d may be an example of any of the base stations 105 described above with reference to the preceding Figures. The UE 115-d of the present example may include one or more antenna(s) 605 communicatively coupled to receiver module(s) 610 and transmitter module(s) 615, which may in turn be communicatively coupled to a control module 620.

The control module 620 may include one or more processor module(s) 625, a memory 630 that contains software 635 for execution by processor module 625, a UE capability module 284-a, a signaling module 286-a, and a communications module 640. One or more components of the UE capability module 284-a, the signaling module 286-a, or the communications module 640 may be implemented by software 635 in memory 630 that is executed by processor module 625. The UE capability module 284-a and the signaling module 286-a may be examples of the UE capability module 284 and the signaling module 286 of FIG. 2, respectively.

The UE capability module 284-a may be configured to retrieve a performance capability of the UE 115-d in relation to a feature (e.g., carrier aggregation) of the wireless communication system 600 for which a minimum performance capability is specified by a wireless communication standard (e.g., LTE-Advanced). In certain examples, this may include reading a stored value of the performance capability of the UE from memory 630. The stored value may include an express indication that the performance capability of the UE is below the minimum performance capability specified by the wireless communication standard. Alternatively, the stored value may include only the performance capability of the UE, and the non-compliance with the minimum performance capability defined by the standard may be implicitly indicated by the performance capability of the UE in comparison to the minimum performance capability defined by the standard. In certain examples, the UE capability module 284-a may retrieve or identify one or more of a number of predetermined performance capability levels as matching the performance capability of the UE 115-d. In certain examples, multiple predetermined performance capability levels may indicate varying grades of non-compliance with the wireless standard.

The signaling module 286-a may be configured to signal to the base station 105-d a capability of the UE 115-d to support the wireless communication feature at a reduced level that is below the minimum performance capability specified by the wireless communication standard. For example, the output power of the UE 115-d may be less than a minimum output power specified in the wireless communication standard for supporting carrier aggregation. In this example, the signaling module 286-a may cause transmitter module(s) 615 to signal to the base station 105-d that the UE 115-d is capable of supporting carrier aggregation at a non-compliant power level. The signaling module 286-a may provide this information to the base station 105-d using one or more UE capability information messages (e.g., any of the UE capability information messages 310 of FIGS. 3, 4A-4C, or 5). In certain examples, this signaling may include the one or more identified predetermined performance capability levels matching the performance capability of the UE 115-d.

The communications module 640 may be configured to control the transmitter module(s) 610 and the receiver module(s) 610 to communicate with the base station 105-d using the feature at the reduced level in response to the signaling generated at the signaling module 286-a. In certain examples, the communications module 640 may receive scheduling information from the base station 105-d for the communications between the base station 105-d and the UE 115-d.

The processor module 625 may include an intelligent hardware device, e.g., a central processing unit (CPU) such as those made by QUALCOMM Incorporated, Intel®

Corporation or AMD®, a microcontroller, an application specific integrated circuit (ASIC), etc. The memory 630 may include random access memory (RAM) and read-only memory (ROM). The memory 630 may store computer-readable, computer-executable software code 635 containing instructions that are configured to, when executed (or when compiled and executed), cause the processor module 625 to perform various functions described herein.

The transmitter module(s) 615 may transmit to base station 105-d (and/or other base stations) to establish communications with one or more wireless communications networks (e.g., E-UTRAN, UTRAN, etc.), as described above. The receiver module(s) 620 may receive downlink transmissions from base station 105-d (and/or other base stations), as described above. Downlink transmissions may be received and processed at the UE 115-d.

The components of the UE 115-d may, individually or collectively, be implemented with one or more Application Specific Integrated Circuits (ASICs) adapted to perform some or all of the applicable functions in hardware. Each of the noted modules may be a means for performing one or more functions related to operation of the UE 115-d.

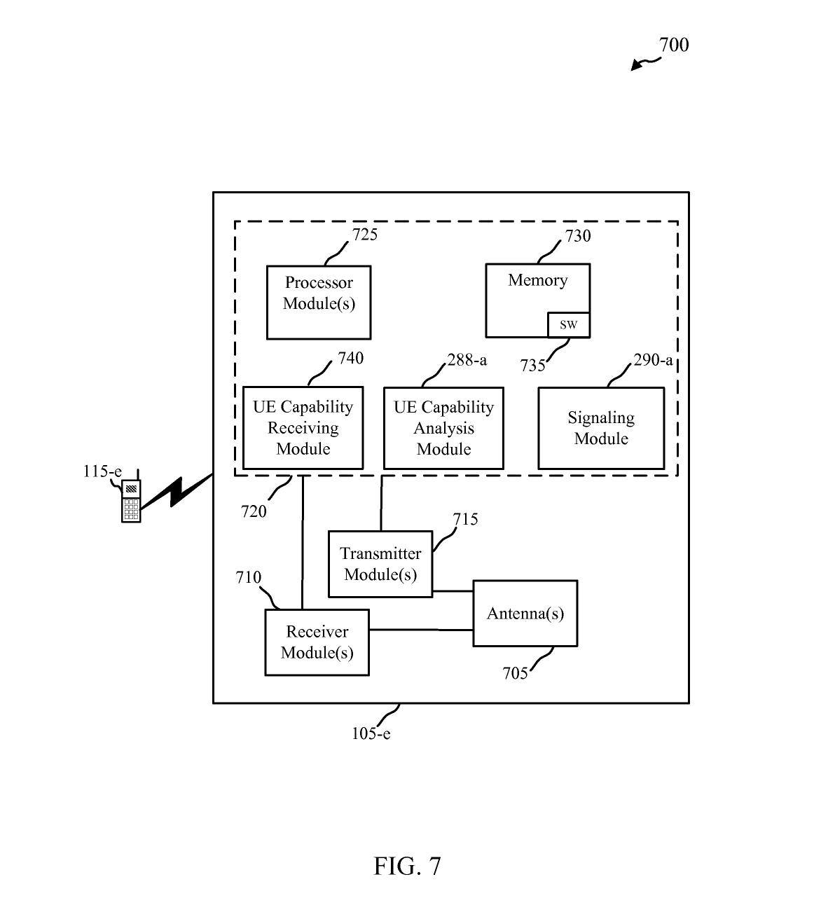

FIG. 7 is an example wireless communication system 700 that provides for the use of a wireless communication feature at a reduced level according to the principles described herein. The system 700 includes a base station 105-e that that may communicate with a UE 115-e to receive access to one or more wireless networks, as described above. The base station 105-e may be an example of any of the base stations 105 described above with reference to the preceding Figures, and the UE 115-e may be an example of any of the UEs 115 described above with reference to the preceding Figures. The base station 105-e of the present example may include one or more antenna(s) 705 communicatively coupled to receiver module(s) 710 and transmitter module(s) 715, which may in turn be communicatively coupled to a control module 720.

The control module 720 may include one or more processor module(s) 725, a memory 730 that contains software 735 for execution by processor module 725, a UE capability receiving module 740, a UE capability analysis module 288-a, and a signaling module 290-a. One or more components of the UE capability receiving module 740, the UE capability analysis module 288-a, or the signaling module 290-a may be implemented by the software 735 in memory 730 that is executed by processor module 725. Additionally, the UE capability analysis module 288-a and the signaling module 290-a may be examples of the UE capability analysis module 288 and the signaling module 290 described above with reference to FIG. 2.

The UE capability receiving module 740 may be configured to receive a capability information from the UE 115-e. In certain examples, the received capability information may be in the form of one or more of the UE capability information messages 310 described above with reference to FIGS. 3, 4A-4C, or 5.

The UE capability analysis module 745 may determine from the capability information message that the UE 115-e supports a wireless communication feature (e.g., carrier aggregation, etc.) at a reduced level that is below a minimum performance capability specified by a wireless communication standard (e.g., LTE-Advanced or another specification, a standard associated with a wireless company or provider, etc.). The UE capability analysis module 745 may further determine whether it is feasible, permissible, or beneficial to allow the UE 115-e to communicate with the base station 105-e using the wireless feature at the non-compliant reduced level.

In response to the UE capability analysis module 745 determining to permit the UE 115-e to communicate with the base station 105-e at the non-compliant reduced level, the signaling module 290-a may control the transmitter module(s) 715 and the receiver module(s) 710 to signal permission to use the wireless communication feature at the reduced level to the UE 115-e. In certain examples, the permission may be signaled as scheduling information to the UE 115-e for communicating with the UE 115-e using the wireless communication feature at the non-compliant reduced level. The base station 105-e may then communicate with the UE 115-e according to the scheduling information. Additionally or alternatively, the signaling module 290-a may signal the permission to the UE 115-e as a message expressly authorizing the UE 115-e to use the wireless communication feature at the reduced level.

The processor module 725 may include an intelligent hardware device, e.g., a central processing unit (CPU) such as those made by Intel® Corporation or AMD®, a microcontroller, an application specific integrated circuit (ASIC), etc. The memory 730 may include random access memory (RAM) and read-only memory (ROM). The memory 730 may store computer-readable, computer-executable software code 735 containing instructions that are configured to, when executed (or when compiled and executed), cause the processor module 725 to perform various functions described herein.

The transmitter module(s) 715 may transmit to UE 115-e (and/or other base stations) to establish communications over one or more wireless communications networks (e.g., E-UTRAN, UTRAN, etc.), as described above. The receiver module(s) 720 may receive downlink transmissions from UE 115-e (and/or other UEs), as described above. Uplink transmissions may be received and processed at the base station 105-e.

The components of the base station 105-e may, individually or collectively, be implemented with one or more Application Specific Integrated Circuits (ASICs) adapted to perform some or all of the applicable functions in hardware. Each of the noted modules may be a means for performing one or more functions related to operation of the base station 105-e.

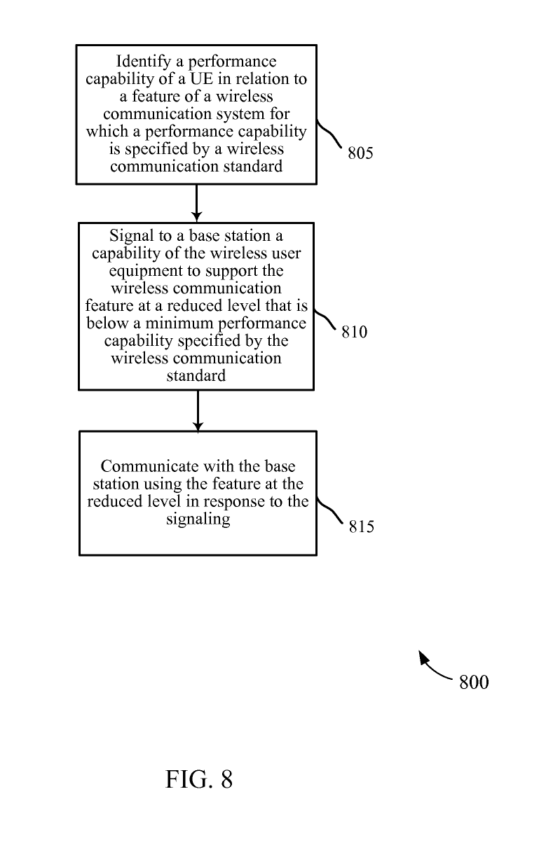

FIG. 8 illustrates a method 800 of wireless communication that may be carried out by a UE to establish communication with a base station according to various embodiments. The method 800 may, for example, be performed by a UE 115 of FIG. 1, 2, 3, 5, 6, or 7, or using a combination of the devices described in the preceding figures.

Initially, at block 805, a UE may retrieve a performance capability of the UE in relation to a feature of a wireless communication system for which a performance capability is specified by a wireless communication standard. In certain examples, the UE may read an indication, stored by the UE, that the performance capability of the UE is below the minimum performance capability associated with supporting the wireless communication feature as specified by the wireless communication standard. For example, the wireless communication feature may be carrier aggregation, and the wireless communication standard may be a version of the LTE standard, such as LTE-Advanced or a related or later standard. The minimum performance capability specified by the wireless communication standard may include, but is not limited to, one or more minimum requirements related to output power, frequency error, transmit intermodulation, reference sensitivity power level, power input level, adjacent channels, blocking characteristics, spurious response, spurious emissions, or receiver image requirements.

In certain examples, the minimum performance capability specified by the wireless communication standard may differ for different bands. Additionally, in certain examples the minimum performance capability specified by the wireless communication standard for downlink transmissions may differ from the minimum performance capability specified by the wireless communication standard for uplink transmissions. As such, the UE may communicate with the base station at the reduced level on one or more of the frequency bands in response to an indication from the base station.

In certain examples, the UE may further determine that a performance capability of the UE is less than the minimum performance capability associated with supporting the wireless communication feature specified by the wireless communication standard. For example, the UE may determine that an output power of the UE is lower than a minimum requirement for output power associated with supporting the wireless communication as specified by the wireless communication feature. In additional or alternative examples, the UE may determine that the UE does not support the wireless communication feature for an entire band specified by the wireless communication standard.

At block 810, the UE may signal to a base station that the UE is capable of supporting the wireless communication feature at a reduced level that is below the minimum performance capability specified by the wireless communication standard. In certain examples, the UE may signal a UE capability message 310 including one or more of the elements described above with reference to FIGS. 4A-4C. In some examples, the UE may retrieve one of a number of predetermined performance capability levels, where the one of the predetermined levels is associated with the performance capability of the UE, and transmit the matched predetermined level as the reduced level that is signaled to the base station.

Returning to the example where the output power of the UE is lower than a minimum requirement for output power associated with supporting the wireless communication, the UE may match its current output power capabilities to one of a number of predetermined levels corresponding to different levels of output power below the minimum output power required by the standard. The UE may provide the selected output power level to the base station when signaling the reduced support for the wireless communication feature.

In the example where the UE is unable to support the wireless communication for an entire band specified in the wireless communication standard, the UE may select one of a number of predetermined levels indicative of the division of the band into subbands. The selected level may indicate a subband of the band for which the UE is capable of supporting the wireless communication feature. The UE may provide the selected subband to the base station when signaling the reduced support for the wireless communication feature.

At block 815, the UE may communicate with the base station using the wireless communication feature at the reduced level based on an indication from the base station. For example, the use of the wireless communication feature at the reduced level in the communication with the base station may be conditioned upon the receipt of permission from the base station. In certain examples, after the UE has signaled its reduced capability for supporting the wireless communication feature, the base station may determine to use the wireless communication feature to the extent supported by the UE and schedule the UE for communications using the wireless communication feature. For example, the base station may schedule the UE to communicate with the base station using the wireless communication feature at a reduced output power, or within a subband of frequencies specified by the UE.

Alternatively, the base station may determine not to allow the UE to use the wireless communication feature at the reduced level and schedule the UE for communications without using the wireless communication feature.

In certain examples, the UE may be capable of fully supporting the wireless communication feature according to the standard in one mode and supporting the wireless communication feature only at a reduced level in another mode. For example, the UE may be capable of fully supporting carrier aggregation according to the standard in a downlink direction, but the UE may not have sufficient output power to support carrier aggregation in an uplink direction according to the specification. In this example, the base station may determine that the output power of the UE is sufficient given the proximity of the UE to the base station, and schedule the UE to communicate with the base station using the carrier aggregation feature at the reduced output power in the uplink direction and without modification to the standard in the downlink direction. In another example, the UE may be capable of supporting carrier aggregation in only a subband of a band specified by the standard, but capable of fully supporting carrier aggregation in a second band specified by the standard. In this example, the base station may schedule the UE to communicate with the base station using carrier aggregation within anywhere within the second band and only within the specified subband of the first band.

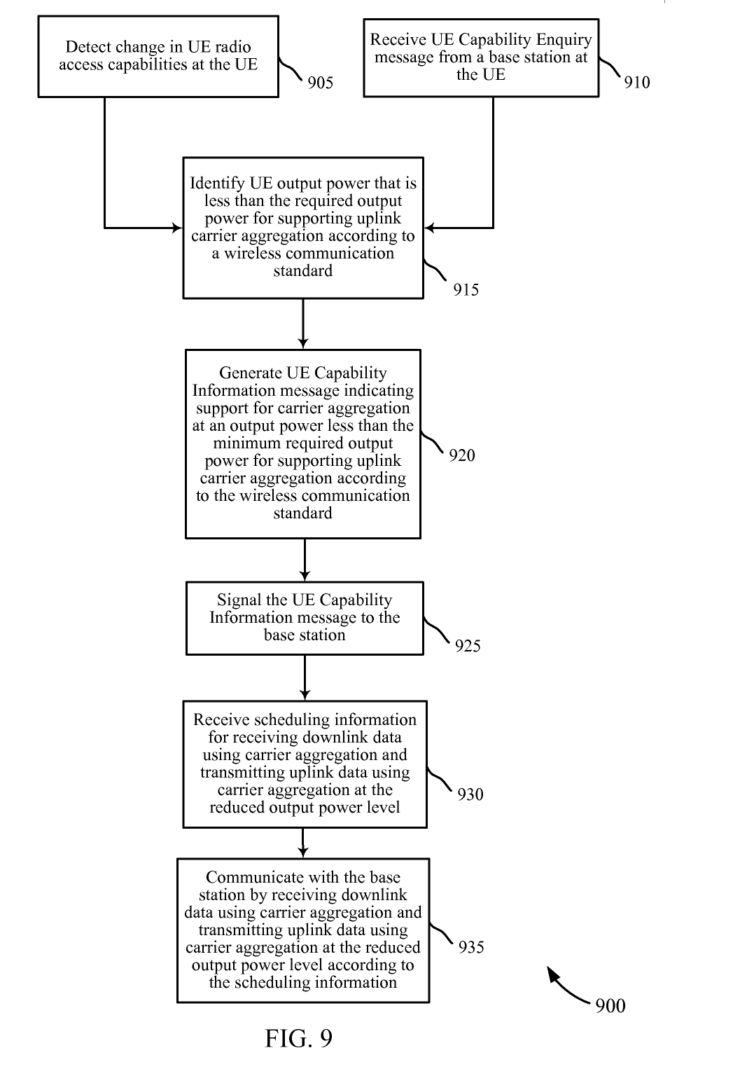

FIG. 9 illustrates a method 900 of wireless communication that may be carried out by a UE to establish communication with a base station according to various embodiments. The method 900 may, for example, be performed by a UE 115 of FIG. 1, 2, 3, 5, 6, or 7, or using any combination of the devices described in the preceding figures.

In the example of FIG. 9, a UE may be transmit its capability information to a base station in response to one of two triggers. At block 905, the first of these triggers occurs if the UE detects a change in its radio access capabilities. At block 910, the second of these triggers occurs if the UE receives a Capability Enquiry message from the base station. In response to either of these triggers, the UE may, at block 915, retrieve an indication of UE output power that is less than the required output power for supporting carrier aggregation according to a wireless communication standard.

At block 920, the UE may generate a UE Capability Information message indicating support for carrier aggregation at an output power less than the minimum required output power for supporting carrier aggregation according to the wireless communication standard. At block 925, the UE may signal the UE Capability Information message to the base station. The UE Capability Information message may include one or more of the elements of the UE Capability Information messages 310 described above with reference to FIGS. 4A-4C. At block 930, the UE may receive scheduling information to receive downlink data using carrier aggregation according to the wireless communication standard and to transmit uplink data using carrier aggregation at the reduced output power level. At block 935, the UE may communicate with the base station by receiving downlink data using carrier aggregation according to the wireless communication standard and transmitting uplink data using carrier aggregation at the reduced output power level according to the scheduling information.

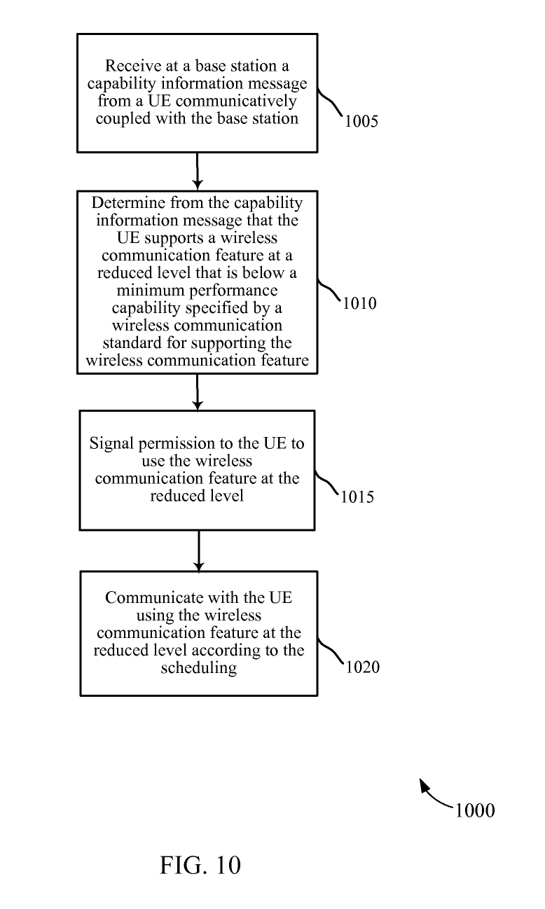

FIG. 10 illustrates a method 1000 of wireless communication that may be carried out by a base station to communicate with a UE according to various embodiments. The method 1000 may, for example, be performed by a base station 105 of FIG. 1, 2, 3, 5, 6, or 7, or using any combination of the devices described in the preceding figures.

Initially, at block 1005, capability information message is received at the base station from a UE communicatively coupled with the base station. The capability information message may include one or more elements of the UE Capability Information 310 messages described above with reference to FIGS. 4A-4C. The capability information message may describe various capabilities of the UE and wireless communication features supported by the UE.

At block 1010, the base station may determine from the capability information message that the UE supports a wireless communication feature at a reduced level that is blow a minimum capability specified by a wireless communication standard for supporting that feature. For example, the capability information message may indicate that the UE supports carrier aggregation, but that the UE does not meet a minimum output power requirement or support an entire band specified by a particular version of the LTE specification or another standard. In certain examples, the base station may identify from the capability information message that the UE supports the wireless communication feature at one of a number of predetermined levels that are below the minimum performance capability specified by the wireless communication standard. Additionally or alternatively, the base station may determine from the capability information message a direction (i.e. uplink or downlink) for which the UE supports the wireless communication feature at the reduced level.

At block 1015, the base station may signal permission to the UE to use the wireless communication feature at the reduced level. In certain examples, this signaling may include scheduling the UE for communication with the base station using the wireless communication feature at the reduced level. Additionally or alternatively, the signaling may include a message transmitted to the UE expressly indicating permission to use the wireless communication feature at the reduced level. In some examples, this scheduling may occur after a determination that communications with the UE are feasible and permissible at the reduced level based on the received capability information message and/or other considerations. In examples where the UE supports the wireless communication feature in full compliance with the standard in a downlink direction and at an output power below the minimum output power specified in the standard, the base station may schedule the UE to receive downlink data using the wireless communication feature according to the standard and transmit uplink data using the feature at the output power below the minimum specified in the standard. In examples where the UE supports the wireless communication feature for only a portion of a band specified in the standard, the base station may schedule the UE to transmit or receive data using the feature only within the supported portion of the band.

At block 1020, the base station may communicate with the UE using the wireless communication feature at the reduced level according to the scheduling. In one example, the base station may communicate with the UE in the uplink direction using the wireless communication feature at the reduced level in response to a determination that the received signal strength of the UE is sufficient to enable uplink communications using the feature at the reduced level.

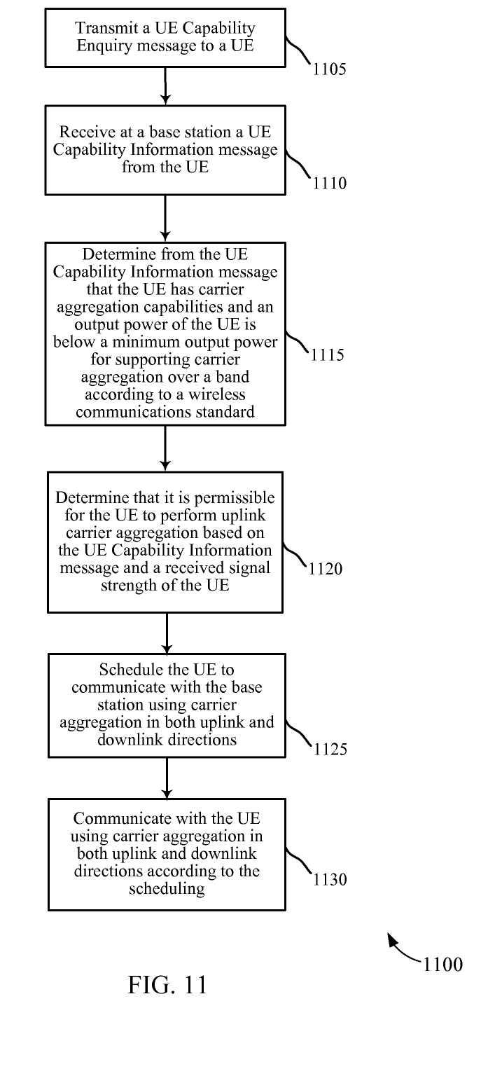

FIG. 11 illustrates a method 1100 of wireless communication that may be carried out by a base station to communicate with a UE according to various embodiments. The method 1100 may, for example, be performed by a base station 105 of FIG. 1, 2, 3, 5, 6, or 7, or using any combination of the devices described in the preceding figures.

At block 1105, the base station may transmit a UE Capability Enquiry message to the UE. At block 1110, the base station may receive a UE Capability Information message from the UE in response to the UE Capability Enquiry message. The UE Capability Information message may be an example of any of the UE Capability Information messages 310 shown in FIGS. 4A-4C. At block 1115, the base station may determine from the UE Capability Information message that the UE has carrier aggregation capabilities and that an output power of the UE is below a minimum output power for supporting carrier aggregation over a band according to a wireless communications standard enforced at the system.

At block 1120, the base station may determine that it is permissible for the UE to perform uplink carrier aggregation based on the UE Capability Information message and a received signal strength of the UE. At block 1125, the base station may schedule the UE to communicate with the base station using carrier aggregation in both uplink and downlink directions. At block 1130, the base station may communicate with the UE using carrier aggregation in both uplink and downlink direction according to the scheduling.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL) then the coaxial cable, fiber optic cable, twisted pair, or DSL are included in the definition of medium. Disk and disc, as used herein, include compact disc (CD), laser disc, optical disc, digital versatile disc (DVD), floppy disk and Blu-Ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method of wireless communication by a user equipment (UE) in a wireless communication system, comprising:
retrieving a performance capability of the UE in relation to a feature of the wireless communication system for which a minimum performance capability is specified by a wireless communication standard;
signaling to a base station a capability of the UE to support the wireless communication feature at a reduced level that is below a minimum performance capability specified by the wireless communication standard; and
communicating with the base station using the feature at the reduced level based on an indication from the base station.

2. The method of claim 1, further comprising:
receiving the indication as permission to use the wireless communication feature at the reduced level from the base station; and
conditioning the use of the wireless communication feature at the reduced level by the UE on the permission received from the base station.

3. The method of claim 2, wherein receiving permission to use the wireless communication feature at the reduced level from the base station comprises:
receiving scheduling instructions from the base station for transmitting uplink data to the base station using the wireless communication feature.

4. The method of claim 2, further comprising:
receiving the indication as a message from the base station authorizing communication using the feature at the reduced level.

5. The method of claim 2, further comprising:
receiving the indication as a radio resource control (RRC) configuration message enabling use of the feature.

6. The method of claim 1, further comprising:
receiving a message from the base station rejecting communication using the feature at the reduced level; and
refraining from communicating with the base station using the feature at the reduced level in response to the message.

7. The method of claim 1, wherein retrieving the performance capability of the UE comprises:
retrieving a stored indication of the performance capability of the UE;
wherein the signaling to the base station occurs in connection with a capabilities exchange process.

8. The method of claim 1, wherein the signaling to the base station comprises:
indicating support for the feature at one or more of a plurality of predetermined performance capability levels.

9. The method of claim 1, wherein the performance capability of the UE comprises support for a carrier aggregation feature of the wireless communication system.

10. The method of claim 9, wherein the signaling to the base station comprises:
signaling to the base station the capability of the UE to support the carrier aggregation feature at the reduced level in an uplink direction and at a level specified by the wireless communication standard in the downlink direction.

11. The method of claim 10, further comprising:
transmitting uplink signals to the base station at a reduced output power; and
receiving the downlink transmissions from the base station in accordance with the wireless communication standard.

12. The method of claim 1, wherein the retrieving the performance capability of the UE comprises:
identifying the performance capability of the UE in relation to a plurality of frequency bands.

13. The method of claim 12, further comprising:
communicating with the base station at the reduced level on one or more of the plurality of frequency bands.

14. The method of claim 1, wherein the wireless communication standard comprises a version of a Long-Term Evolution (LTE) standard.

15. A user equipment (UE) apparatus, comprising:
a UE capability module configured to retrieve a performance capability of the UE in relation to a feature of a wireless communication system for which a minimum performance capability is specified by a wireless communication standard;
a signaling module configured to signal to a base station a capability of the UE to support the wireless communication feature at a reduced level that is below a minimum performance capability specified by the wireless communication standard; and
a communications module configured to communicate with the base station using the feature at the reduced level based on an indication from the base station.

16. The UE apparatus of claim 15, wherein the indication comprises permission from the base station to use the wireless communication feature at the reduced level.

17. The UE apparatus of claim 15, wherein the signaling module is further configured to:
receive the indication as a set of scheduling instructions from the base station for transmitting uplink data to the base station using the wireless communication feature.

18. The UE apparatus of claim 15, wherein the signaling module is further configured to receive the indication as a message from the base station authorizing communication using the feature at the reduced level.

19. The UE apparatus of claim 15, wherein the signaling module is further configured to receive the indication as a radio resource control (RRC) configuration message enabling use of the feature.

20. The method of claim 15, wherein:
the signaling module is further configured to receiving a message from the base station rejecting communication using the feature at the reduced level; and
the communications module is further configured to refrain from communicating with the base station using the feature at the reduced level in response to the message.

21. The UE apparatus of claim 15, wherein the UE capability module is further configured to:
retrieve a stored indication of the performance capability of the UE;
wherein the signaling to the base station occurs in connection with a capabilities exchange process.

22. The UE apparatus of claim 15, wherein the UE capability module is further configured to:
indicate support for the feature at one or more of a plurality of predetermined performance capability levels.

23. The UE apparatus of claim 15, wherein the performance capability of the UE comprises support for a carrier aggregation feature of the wireless communication system.

24. The UE apparatus of claim 23, wherein:
the signaling module is further configured to signal to the base station the capability of the UE to support the carrier aggregation feature at the reduced level in an uplink direction and at level specified by the wireless communication standard in the downlink direction; and
the communications module is further configured to transmit the uplink transmissions to the base station at a reduced output power and receive the downlink transmissions from the base station in accordance with the wireless communication standard.

25. The UE apparatus of claim 15, wherein the UE capability module is further configured to:
identify the performance capability of the UE in relation to a plurality of frequency bands.

26. The UE apparatus of claim 25, wherein the communications module is further configured to:
communicate with the base station using the wireless communication feature at the reduced level on one or more of the plurality of frequency bands.

27. The UE apparatus of claim 15, wherein the wireless communication standard comprises a version of a Long-Term Evolution (LTE) standard.

28. A user equipment (UE) apparatus, comprising:
means for retrieving a performance capability of the UE in relation to a feature of a wireless communication system for which a minimum performance capability is specified by a wireless communication standard;
means for signaling to a base station a capability of the UE to support the wireless communication feature at a reduced level that is below a minimum performance capability specified by the wireless communication standard; and
means for communicating with the base station using the feature at the reduced level based on an indication from the base station.

29. The UE apparatus of claim 28, further comprising:
means for receiving the indication as permission to use the wireless communication feature at the reduced level from the base station; and
means for conditioning the use of the wireless communication feature at the reduced level by the UE on the permission received from the base station.

30. The UE apparatus of claim 29, further comprising:
means for receiving scheduling instructions from the base station for transmitting uplink data to the base station using the wireless communication feature.

31. The UE apparatus of claim 29, further comprising:
means for receiving the indication as a message from the base station authorizing communication using the feature at the reduced level.

32. The UE apparatus of claim 29, further comprising:
means for receiving the indication as a radio resource control (RRC) configuration message enabling use of the feature.

33. The UE apparatus of claim 28, further comprising:
receiving a message from the base station rejecting communication using the feature at the reduced level; and
means for refraining from communicating with the base station using the feature at the reduced level in response to the message.

34. The UE apparatus of claim 28, wherein the means for retrieving the performance capability of the UE comprises:
means for retrieving a stored indication of the performance capability of the UE;
wherein the signaling to the base station occurs in connection with a capabilities exchange process.

35. The UE apparatus of claim 28, wherein the means for signaling to the base station comprises:
means for indicating support for the feature at one or more of a plurality of predetermined performance capability levels.

36. The UE apparatus of claim 28, wherein the performance capability of the UE comprises support for a carrier aggregation feature of the wireless communication system.

37. The UE apparatus of claim 36, wherein the means for signaling to the base station comprises:
means for signaling to the base station the capability of the UE to support the carrier aggregation feature at the reduced level in an uplink direction and at a level specified by the wireless communication standard in the downlink direction.

38. The UE apparatus of claim 37, further comprising:
means for transmitting uplink signals to the base station at a reduced output power; and
means for receiving the downlink transmissions from the base station in accordance with the wireless communication standard.

39. The UE apparatus of claim 28, wherein the means for retrieving the performance capability of the UE comprises:
means for identifying the performance capability of the UE in relation to a plurality of frequency bands.

40. The UE apparatus of claim 39, further comprising:
means for communicating with the base station at the reduced level on one or more of the plurality of frequency bands.

41. The UE apparatus of claim 28, wherein the wireless communication standard comprises a version of a Long-Term Evolution (LTE) standard.

42. A computer program product for wireless communication using a user equipment (UE), comprising:
a tangible computer-readable medium comprising:
code for retrieving a performance capability of the UE in relation to a feature of the wireless communication system for which a minimum performance capability is specified by a wireless communication standard;
code for signaling to a base station a capability of the UE to support the wireless communication feature at a reduced level that is below a minimum performance capability specified by the wireless communication standard; and
code for communicating with the base station using the feature at the reduced level based on an indication from the base station.

43. A method for wireless communication using a base station, comprising:
receiving a capability information message from a user equipment (UE) communicatively coupled with the base station;
determining from the capability information message that the UE supports a wireless communication feature at a reduced level that is below a minimum performance capability specified by a wireless communication standard for supporting the wireless communication feature; and
indicating to the UE whether the wireless communication feature can be used at the reduced level.

44. The method of claim 43, wherein the indicating comprises:
transmitting scheduling instructions to the UE for transmitting uplink data to the base station using the wireless communication feature at the reduced level.

45. The method of claim 43, wherein the indicating comprises:
transmitting a message to the UE indicating permission to use the wireless communication feature at the reduced level.

46. The method of claim 43, further comprising:
determining, based on the capability information message, that communicating with the UE using the wireless communication feature at the reduced level is possible; and
wherein the indicating occurs in response to the determination that communicating with the UE using the wireless feature at the reduced level is possible.

47. The method of claim 46, further comprising:
determining that a received signal strength of the UE is sufficient to enable uplink communications using the wireless feature at the reduced level; and
communicating with the UE in an uplink direction using the wireless communication feature at the reduced level in response to the determination that the received signal strength of the UE is sufficient to enable uplink communications using the wireless communication feature at the reduced level.

48. The method of claim 43, further comprising:
identifying the performance capability of the UE in relation to a plurality of frequency bands; and
communicating with the base station at the reduced level on one or more of the plurality of frequency bands.

49. The method of claim 43, wherein the wireless communication feature comprises a carrier aggregation feature.

50. The method of claim 43, wherein the wireless communication standard comprises a version of a Long-Term Evolution (LTE) standard.

51. A base station apparatus, comprising:
means for receiving a capability information message from a user equipment (UE) communicatively coupled with the base station;
means for determining from the capability information message that the UE supports a wireless communication feature at a reduced level that is below a minimum performance capability specified by a wireless communication standard for supporting the wireless communication feature; and
means for indicating to the UE whether the wireless communication feature can be used at the reduced level.

52. The base station apparatus of claim 51, wherein the means for indicating comprises:
means for transmitting scheduling instructions to the UE for transmitting uplink data to the base station using the wireless communication feature at the reduced level.

53. The base station apparatus of claim 51, wherein the means for indicating comprises:
means for transmitting a message to the UE indicating permission to use the wireless communication feature at the reduced level.

54. The base station apparatus of claim 51, further comprising:
means for determining that a received signal strength of the UE is sufficient to enable uplink communications using the wireless feature at the reduced level;
wherein the means for communicating with the UE comprises communicating with the UE in an uplink direction using the wireless communication feature at the reduced level in response to the determination that the received signal strength of the UE is sufficient to enable uplink communications using the wireless communication feature at the reduced level.

55. The base station apparatus of claim 51, further comprising:
means for identifying the performance capability of the UE in relation to a plurality of frequency bands; and;
means for communicating with the base station at the reduced level on one or more of the plurality of frequency bands.

56. The base station apparatus of claim 51, wherein the wireless communication feature comprises a carrier aggregation feature.

57. The base station apparatus of claim 51, wherein the wireless communication standard comprises a version of a Long-Term Evolution (LTE) standard.
